(19) United States
(12) Patent Application Publication
(10) Pub. No.: US 2019/0147630 A1
(43) Pub. Date: May 16, 2019

(54) MEDICAL IMAGING METHOD, COMPUTER PROGRAM, AND COMPUTER STORAGE

(71) Applicant: General Electric Company, Schenectady, NY (US)

(72) Inventors: Xueli Wang, Beijing (CN); Ximiao Cao, Beijing (CN); Shiyu Li, Beijing (CN)

(21) Appl. No.: 16/176,626

(22) Filed: Oct. 31, 2018

(30) Foreign Application Priority Data
Nov. 16, 2017 (CN) 201711136214.1

(51) Int. Cl. G06T 11/00; G06T 7/13; G06T 7/11

(52) U.S. Cl. CPC G06T 11/008; G06T 7/13; G06T 7/11; G06T 2210/41; G06T 2207/10081; G06T 2207/20221; G06T 2207/20021

(57) ABSTRACT

Embodiments of the present invention provide a medical imaging method, computer program and computer storage medium, the medical imaging method comprising: reconstructing collected raw image data to a first image having a first matrix size; transforming the first image to a second image having a second matrix size, the second matrix size being smaller than the first matrix size; and displaying the second image.

### FIELD OF THE INVENTION

The present invention relates to the medical detection field, and particularly to a medical imaging method, computer program and computer storage medium.

### BACKGROUND OF THE INVENTION

In a medical imaging system, for example, a computing tomography (CT), a doctor may diagnose a disease by observing a scanned image displayed in a display.

In an existing medical imaging system, there are many reasons causing the scanned image presented to a user to have a smaller matrix size, e.g., 512*512. These reasons involve, for example, restriction on the physical pixel size of the display itself, data processing speed of the computer, the doctor's wish to present a plurality of images simultaneously for comparison to obtain a more accurate diagnosis result, etc.

Therefore, in the prior art, the image with a smaller matrix size is reconstructed directly according to the raw scanned data, and is presented to the user after being filtered for disease diagnosing. However, evenness, definition and the like of the image are not ideal. One reason that causes such a problem may be that the number of the detector channels is greater than the number of the pixel matrix units.

In order to overcome the above problem, one method is to sacrifice the field of view of the display, i.e., to improve the image quality by defining a smaller field of view of the display; another method is to reconstruct and display an image with a larger matrix size, which needs to increase the image post-processing speed of the computer, the physical resolution of the display, the memory size and the like accordingly. Moreover, it is found from a survey that for the above reasons, even if an image with a larger matrix size (e.g., 1024*1024) is presented to the users, very few users are willing to use it. Therefore, displaying an image with a smaller matrix size will still be the main method for presenting an image.

Hence, if a scanned image with a higher quality can be presented to the users based on existing hardware facilities of a medical imaging system, market competitiveness of the medical imaging system can be improved.

### BRIEF DESCRIPTION OF THE INVENTION

An objective of the present invention is to provide a medical imaging method, which can improve the quality of the displayed scanned image based on the existing hardware facilities of a medical imaging system.

Exemplary embodiments of the present invention provide a medical imaging method, comprising: reconstructing collected raw image data to a first image having a first matrix size; transforming the first image to a second image having a second matrix size, the second matrix size being smaller than the first matrix size; and displaying the second image.

The exemplary embodiments of the present invention also provide a computer program configured to cause a computer of a medical imaging system to execute the following instructions: reconstructing collected raw image data to a first image having a first matrix size; transforming the first image to a second image having a second matrix size, the second matrix size being smaller than the first matrix size; and displaying the second image.

The exemplary embodiments of the present invention further provide a computer storage medium for storing the computer program as mentioned above.

Other features and aspects will be apparent through the following detailed description, figures and claims.

### BRIEF DESCRIPTION OF THE DRAWINGS

The present invention can be better understood in light of the description of exemplary embodiments of the present invention with reference to the accompanying drawings, in which:

FIG. 1 is a flow chart of a medical imaging method provided by one embodiment of the present invention;

FIG. 2 is a comparison chart between an image obtained utilizing the embodiment of the present invention and an image obtained by reconstructing directly utilizing the prior art, when imaging one body part;

FIG. 3 is a comparison chart between an image obtained utilizing the embodiment of the present invention and images obtained by reconstructing directly utilizing the prior art, when imaging another body part;

FIG. 4 is a comparison chart between an image obtained utilizing the embodiment of the present invention and images obtained by reconstructing directly utilizing the prior art, when imaging another body part;

FIG. 5 is a comparison chart between an image obtained utilizing the embodiment of the present invention and images obtained by reconstructing directly utilizing the prior art, when imaging another body part.

### DETAILED DESCRIPTION OF THE INVENTION

Hereafter, a detailed description will be given for preferred embodiments of the present disclosure. It should be pointed out that in the detailed description of the embodiments, for simplicity and conciseness, it is impossible for the Description to describe all the features of the practical embodiments in details. It should be understood that in the process of a practical implementation of any embodiment, just as in the process of an engineering project or a designing project, in order to achieve a specific goal of the developer and in order to satisfy some system-related or business-related constraints, a variety of decisions will usually be made, which will also be varied from one embodiment to another. In addition, it can also be understood that although the effort made in such developing process may be complex and time-consuming, some variations such as design, manufacture and production on the basis of the technical contents disclosed in the disclosure are just customary technical means in the art for one of ordinary skilled in the art associated with the contents disclosed in the present disclosure, which should not be regarded as insufficient disclosure of the present disclosure.

Unless defined otherwise, all the technical or scientific terms used in the Claims and the Description should have the same meanings as commonly understood by one of ordinary skilled in the art to which the present disclosure belongs. The terms “first”, “second” and the like in the Description and the Claims of the present utility model do not mean any sequential order, number or importance, but are only used for distinguishing different components. The terms “a”, “an” and the like do not denote a limitation of quantity, but denote the existence of at least one. The terms “comprises”, “comprising”, “includes”, “including” and the like mean that the element or object in front of the “comprises”, “comprising”, “includes” and “including” covers the elements or objects and their equivalents illustrated following the “comprises”, “comprising”, “includes” and “including”, but do not exclude other elements or objects. The term “coupled” or “connected” or the like is not limited to being connected physically or mechanically, nor limited to being connected directly or indirectly.

The embodiments of the present invention may be used in a medical imaging system that may comprise a CT imaging system and a magnetic resonance imaging system. The present invention is described using a CT imaging system as an example. In one embodiment, the CT imaging system may comprise a scanning system including a gantry on which a cylindrical scanning cavity is formed to accommodate an object to be scanned and support a bed board of the object to be scanned. A bulb and a detector are provided oppositely on the gantry. An X-ray emitted by the bulb penetrates the human tissue and then is received by the detector. The X-ray received by the detector is converted into a digital image signal.

The CT imaging system further comprises a data collection system and an image reconstruction system. The data collection system is configured to collect the digital image signal and transmit it as raw image data to the image reconstruction system for image reconstruction. The image reconstruction system may be arranged on a computer and the image obtained by reconstruction may be displayed on a display connected to the computer. The image obtained by reconstruction consists of a plurality of pixels arranged in a form of digital matrix.

The CT imaging system further comprises a control system, which may also be arranged on the computer for controlling the scanning system, the data collection system and the image reconstruction system.

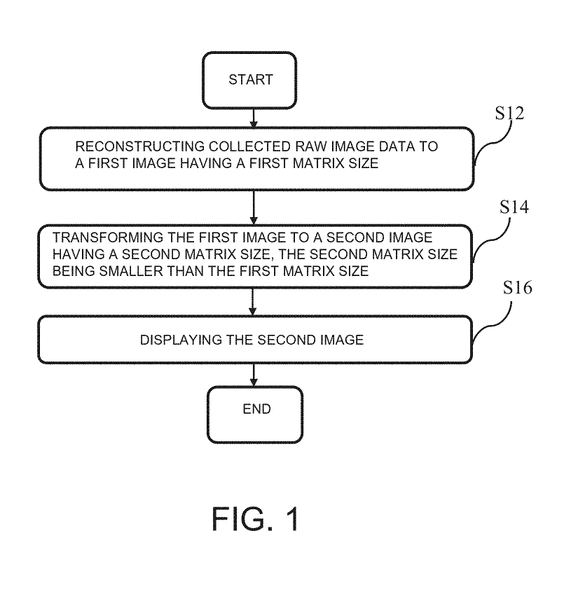

FIG. 1 is a flow chart of a medical imaging method provided by one embodiment of the present invention. As shown in FIG. 1, the method comprises the following Steps S12, S14 and S16:

Step S12: reconstructing collected raw image data to a first image having a first matrix size;

Step S14: transforming the first image to a second image having a second matrix size, wherein the second matrix size is smaller than the first matrix size;

Step S16: displaying the second image.

For example, by the above steps, the raw image data may first be reconstructed to an image that has more pixels in both horizontal and vertical directions of a pixel matrix thereof (for example, its matrix size may be 1024*1024), then the pixels in the horizontal and vertical directions of the pixel matrix thereof are both reduced by a transformation processing to obtain an image having a target matrix size (for example, 512*512), and finally the transformed image is displayed. Compared with reconstructing the image having the target matrix size directly, the displayed image has a better evenness and definition.

In order to adapt to more application scenarios, a step of storing the first image may further be included. For example, when the user tends more to use a display with a higher resolution, the stored first image may be called directly.

Furthermore, in Step S14, the first image may be transformed to the second image by merging each plurality of matrix units of the first image to one matrix unit.

For example, in Step S14, the step of transforming the first image to the second image may comprise the following steps:

dividing the first image into a plurality of regions equally; merging matrix units covered by each of the regions, wherein each matrix unit has the same merging weight.

Taking a first image with a size of 1024*1024 as an example, each neighboring four (2*2) matrix units may be merged to one matrix unit. The pixel value of the one matrix unit is a mean of the pixel values of the four matrix units. Therefore, the merging weight of each pixel value is 25%.

The above transformation has a simple data computation, which will not affect the imaging speed.

For another example, in Step S14, the step of transforming the first image to the second image may also comprise the following steps:

performing an edge detection on the first image; dividing the first image into a plurality of regions and allocating a merging weight to each of matrix units covered by each of the regions based on a result of the edge detection, and merging the matrix units covered by each of the regions according to a merging weight of each matrix unit.

The edge detection technology for images is a well known technology in the art, which will not be described in details herein. By edge detection, more image content information, for example, a profile of the detected object, can be obtained. In order to achieve an edge enhancement effect and to avoid content loss brought by pixel merging, a merging method of non-mean weight may be utilized. For example, a matrix unit containing edge information is made have a larger merging weight than other matrix units. In addition, when dividing the regions to be merged, the regions may be divided equally, or may also be divided unequally. For example, for a matrix unit containing edge information, it may be divided along with the surrounding other plurality of pixels into one region to be merged. This is only one illustrative unequal division method, and surely, other methods for dividing may also be used as long as they can transform an image with a large size to one with a target size, achieve edge enhancement and avoid image distortion as much as possible.

In one embodiment, the first matrix size is 1024*1024 and the second matrix size is 512*512. Surely, the embodiments of the present invention are also adapted to transform the reconstructed images with other sizes to obtain displayed images with other target sizes.

The embodiments of the present invention also provide a computer program configured to cause a computer of a medical imaging system to execute the following instructions:

reconstructing collected raw image data to a first image having a first matrix size;

transforming the first image to a second image having a second matrix size, the second matrix size being smaller than the first matrix size; and

displaying the second image.

Furthermore, the computer program is further configured to cause the computer of the medical imaging system to execute the following instruction: storing the first image.

Optionally, the instruction of transforming the first image to the second image comprises the following sub-instructions:

dividing the first image into a plurality of regions according to the second matrix size, each region including a plurality of matrix units;

merging the plurality of matrix units in each region, wherein each matrix unit has the same merging weight.

Optionally, the instruction of transforming the first image to the second image comprises the following sub-instructions:

performing an edge detection on the first image;

allocating a merging weight to each of matrix units of the first image based on a result of the edge detection, and merging neighboring matrix units of the first image according to a merging weight of each matrix unit.

The embodiments of the present invention further provide a computer storage medium for storing the computer program as mentioned above.

The embodiments of the present invention, during medical imaging, obtain an image with a larger size by reconstruction, then present to the user a restored image with a smaller size obtained by transformation processing, thus improving the image quality while satisfying the user's usage habit and matching existing hardware settings. By utilizing such a totally new idea, an effective solution is obtained, which can, at a very low cost, achieve a technical effect equal to one that needs a higher cost by the prior art, having a higher economic value.

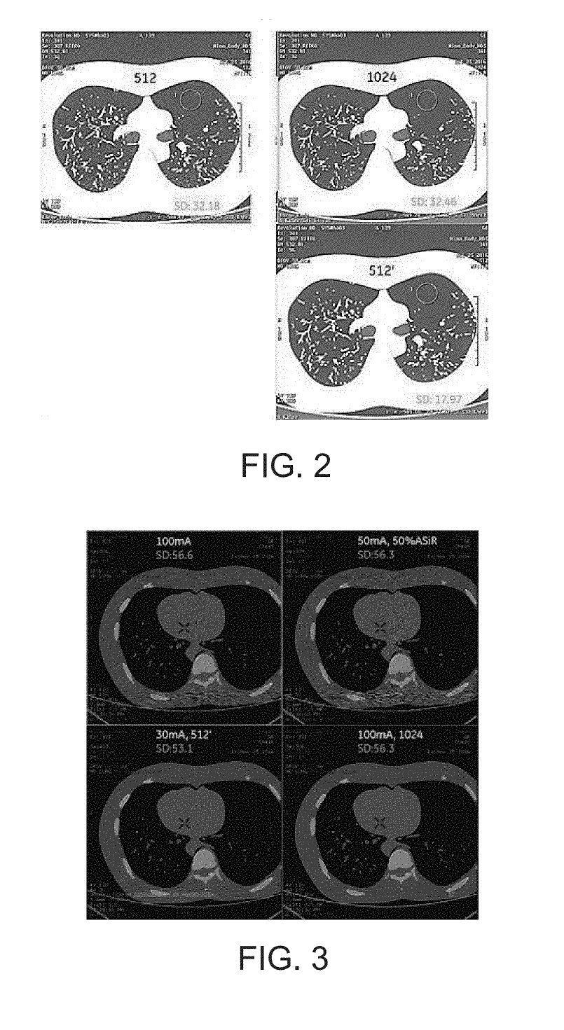

FIG. 2 is a comparison chart between an image obtained utilizing the embodiment of the present invention and an image obtained by reconstructing directly utilizing the prior art, when imaging one body part, in which the upper left in FIG. 2 is an image obtained by reconstruction with a size of 512*512, the upper right in FIG. 2 is an image obtained by reconstruction with a size of 1024*1024, the lower part in FIG. 2 is an image with a size of 512*512 obtained after transforming the image on the upper right by utilizing the embodiment of the present invention. From the comparison between the two images with a size of 512*512 in FIG. 2, it can be seen that the image obtained utilizing the embodiment of the present invention has a smaller standard deviation (SD) of noise and a higher resolution.

FIG. 3 is a comparison chart between an image obtained utilizing the embodiment of the present invention and images obtained by reconstructing directly utilizing the prior art, when imaging another body part, in which the upper left of FIG. 3 is an image with a size of 512*512 from reconstruction directly utilizing the prior art, the upper right of FIG. 3 is an image obtained by further filtering the reconstructed image with a size of 512*512 utilizing the prior art, the lower right of FIG. 3 is an image with a size of 1024*1024 from reconstruction directly by utilizing the prior art, the lower left of FIG. 3 is an image with a size of 512*512 obtained by utilizing the embodiment of the present invention. From the comparison, it can be seen that for the images with the same size (512*512), compared with the images obtained by utilizing the prior art, the image obtained utilizing the embodiment of the present invention has a smaller SD of noise, a higher evenness and a higher definition, and can support scanning with a lower dose (e.g., 30 mA).

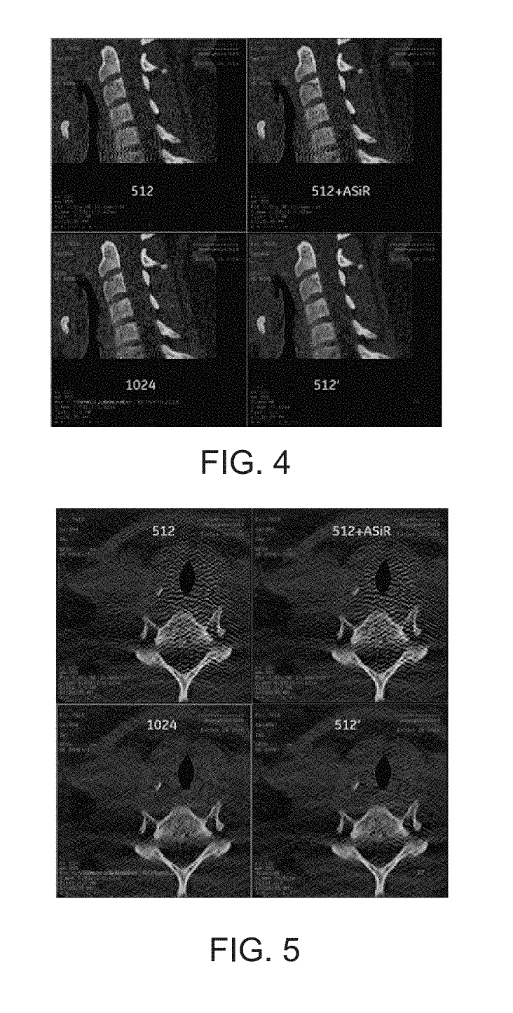

FIG. 4 is a comparison chart between an image obtained utilizing the embodiment of the present invention and images obtained by reconstructing directly utilizing the prior art, when imaging another body part, in which the upper left of FIG. 4 is an image with a size of 512*512 from reconstruction directly utilizing the prior art, the upper right of FIG. 4 is an image obtained by further filtering the reconstructed image with a size of 512*512 utilizing the prior art, the lower left of FIG. 4 is an image with a size of 1024*1024 from reconstruction directly by utilizing the prior art, the lower right of FIG. 4 is an image with a size of 512*512 obtained by utilizing the embodiment of the present invention. From the comparison, it can be seen that for the images with the same size (512*512), compared with the images obtained by utilizing the prior art, the image obtained utilizing the embodiment of the present invention has a higher evenness and a higher definition.

FIG. 5 is a comparison chart between an image obtained utilizing the embodiment of the present invention and images obtained by reconstructing directly utilizing the prior art, when imaging another body part, in which the upper left of FIG. 5 is an image with a size of 512*512 from reconstruction directly utilizing the prior art, the upper right of FIG. 5 is an image obtained by further filtering the reconstructed image with a size of 512*512 utilizing the prior art, the lower left of FIG. 5 is an image with a size of 1024*1024 from reconstruction directly by utilizing the prior art, the lower right of FIG. 5 is an image with a size of 512*512 obtained by utilizing the embodiment of the present invention. From the comparison, it can be seen that for the images with the same size (512*512), compared with the images obtained by utilizing the prior art, the image obtained utilizing the embodiment of the present invention has a higher evenness and a higher definition.

Although some exemplary embodiments have been described as mentioned above, it should be understood that various modifications may still be made. For example, if the described techniques are carried out in different orders, and/or if the components in the described system, architecture, apparatus or circuit are combined in different ways and/or replaced or supplemented by additional components or equivalents thereof, proper results may still be achieved. Accordingly, other implementations also fall within a protection scope of the Claims.

We claim:

1. A medical imaging method, comprising:
reconstructing collected raw image data to a first image having a first matrix size;
transforming the first image to a second image having a second matrix size, the second matrix size being smaller than the first matrix size; and
displaying the second image.

2. The medical imaging method according to claim 1, further comprising:
storing the first image.

3. The medical imaging method according to claim 1, wherein the step of transforming the first image to the second image comprises:
dividing the first image into a plurality of regions equally;
merging matrix units covered by each of the regions, wherein each matrix unit has the same merging weight.

4. The medical imaging method according to claim 1, wherein the step of transforming the first image to the second image comprises:
performing an edge detection on the first image;
dividing the first image into a plurality of regions and allocating a merging weight to each of matrix units covered by each of the regions based on a result of the edge detection, and merging the matrix units covered by each of the regions according to a merging weight of each matrix unit.

5. The medical imaging method according to claim 1, wherein the first matrix size is 1024*1024 and the second matrix size is 512*512.

6. A computer program configured to cause a computer of a medical imaging system to execute the following instructions:
reconstructing collected raw image data to a first image having a first matrix size;
transforming the first image to a second image having a second matrix size, the second matrix size being smaller than the first matrix size; and
displaying the second image.

7. The computer program according to claim 6, wherein the computer program is further configured to cause a computer of a medical imaging system to execute the following instruction:
storing the first image.

8. The computer program according to claim 6, wherein the instruction of transforming the first image to the second image comprises the following sub-instructions:
dividing the first image into a plurality of regions according to the second matrix size, each region including a plurality of matrix units;
merging the plurality of matrix units in each region, wherein each matrix unit has the same merging weight.

9. The computer program according to claim 6, wherein the instruction of transforming the first image to the second image comprises the following sub-instructions:
performing an edge detection on the first image;
allocating a merging weight to each of matrix units of the first image based on a result of the edge detection, and merging neighboring matrix units of the first image according to a merging weight of each matrix unit.

10. A computer storage medium for storing the computer program of claims 6.
